(19) United States
(12) Patent Application Publication
(10) Pub. No.: US 2024/0318607 A1
(43) Pub. Date: Sep. 26, 2024

(54) INTERNAL COOLING METHOD FOR ENGINES AND ENGINE IN WHICH IT IS APPLIED

(71) Applicant: José Luis Bermúdez De Castro De La Fuente, Madrid (ES)

(72) Inventor: José Luis Bermúdez De Castro De La Fuente, Madrid (ES)

(21) Appl. No.: 18/576,408

(22) PCT Filed: Jul. 2, 2022
(86) PCT No.: PCT/ES2022/070423

§ 371 Date: Jan. 4, 2024

(30) Foreign Application Priority Data
Jul. 4, 2021 (ES) P202130625

(51) Int. Cl. F02D 13/02; F01L 1/18; F01L 9/10; F01L 13/00; F01P 3/20; F02D 41/38; F02P 5/15

(52) U.S. Cl. CPC F02D 13/0203; F01L 1/18; F01L 9/10; F01L 13/0015; F01P 3/20; F02D 41/38; F02P 5/1504; F02D 2200/101

(57) ABSTRACT

Internal cooling method for internal combustion engines, comprising any of the following stages: (a) vary the openings and closings of combustion chamber intake and exhaust elements in order to modify the functioning cycle performed by the engine, carrying out just intake and exhaust strokes, without compression or expansion strokes; (b) inject a cooling fluid inside the engine; (c) interrupt the fuel injection and ignition systems.

This method can be implemented in alternation together with a thermodynamic cycle in which the engine produces work.

Combustion engine in which the previously described method is applied, which comprises at least one control unit configured to act on the functioning of combustion chamber intake and exhaust elements, as well as on the injection and ignition systems, and thus implement the stages of said method.

### TECHNICAL FIELD

The present invention refers to internal combustion engines, and more specifically to their internal cooling.

### BACKGROUND ART

Since the first commercial development of the internal combustion engine by Jean J. Lenoir in 1858, and the 4-stroke principle by Nicolaus August Otto in 1876 (document US194047A), there are many variations that have been developed over the last century and a half, in order to improve the operation, durability, consumption, energy performance and emissions of internal combustion engines. Many advances have been made in all these fields, but there is still much progress to be made, especially in terms of innovation in energy performance and emissions.

There are many thermodynamic cycles that take place in internal combustion engines, and almost all of them include the following 4 stages or phases, distributed in 4 or 2-stroke cycles: (1) intake, (2) compression, (3) combustion or explosion or expansion, and (4) exhaust.

The most commercially successful engines are alternative internal combustion engines (in which the gases generated in the exothermic reaction resulting from a combustion process push a piston, moving it inside the cylinder and generating an alternative movement). Commercially, the most successful cycles developed in these alternative internal combustion engines are the Otto cycle and the 4-stroke Diesel cycle. However, there are other cycles with commercial success such as the Atkinson, the Miller or the one developed in the 2-stroke engine, both in gasoline and diesel. Other types of non-alternative engines are also known, such as the Wankel rotary engine or the HEHC (high-efficiency hybrid cycle), or a multitude of exotic engines with little or no commercial success.

Regarding engine elements, many technical advances have been achieved such as injection, direct injection, common rail, turbocharger, catalyst, particulate filters, or more recently urea or AdBlue.

Solutions are also known based on the addition of fluids to the combustion chamber, for purposes other than combustion, such as lubrication, cooling, expansion or even mitigating self-detonation. Among these solutions is the injection of water or other fluids with a high thermal capacity or latent heat of vaporization, which act as a heat “sponge” inside the engine, producing an immediate cooling effect. By cooling the combustion chamber, certain parameters of the thermodynamic cycle can be varied, and an increase in combustion efficiency and power can be achieved. The lower temperature in the combustion chambers in turn leads to lower emissions of pollutants, such as nitrogen oxides and microparticles.

The Saab 99 Turbo S from 1978 was the pioneer car in this technique, which has been improved especially in competition engines. Currently, many high-performance engines inject extra gasoline into the cylinders without combustion purposes, seeking a cooling effect in the combustion chamber instead of using it to propel the engine. The main objective in this case is not so much to improve the efficiency and power of the engines, but simply to cool the engine so that the materials do not suffer damage with extremely high temperatures.

Documents DE102015208472A1 and DE102015208476A1 are also known, which present the Bosch “water boost” system, present since 2016 in the BMW M4 GTS, where distilled water is used instead of extra gasoline to cool the engine, thus saving fuel.

Document US2014326202A1 is also known about a 6-stroke engine cycle, which consists of adding 2 strokes after the usual 4 strokes. These 2 additional strokes are intake (with the intake valve open that fills the combustion chamber with clean air) and exhaust (with the exhaust valve open through which that air is expelled), which produce a sweep of the combustion chamber.

Document DE102004013854A1 is also known, regarding a 6-stroke engine cycle with water injection, where these 2 variations occur compared to the 6-stroke engine cycle:
1. On the one hand, the exhaust valve functioning is modified, so instead of being open during the entire 4th exhaust stroke, it only opens briefly at the end of the 3rd stroke and/or briefly at the beginning of the 4th stroke. In this way, the 4th stroke is no longer an exhaust one but a compression one, compressing a part of the dirty air that remains after the combustion or explosion of the previous stroke.
2. On the other hand, water is injected during the 5th stroke, where the high temperature causes the water to change into a vapor state, greatly increasing the pressure and generating expansion on the piston. In this way, the 5th stroke is no longer an intake one but an expansion one.

Finally, technical solutions are also known that vary the functioning of the valves to adapt their opening and closing moments to different conditions, desired results, or thermodynamic cycles to be developed, such as:
Variable timing solutions that adjust the relative movement of the camshaft with respect to the engine flywheel to change the timing diagram according to the engine speed.
Solutions consisting of displaceable camshafts, with one set of active cams for one position and another set of active cams for the other position. For example, in the engines that Toyota has been marketing very successfully for several years now in its hybrid cars, where in one position of the camshaft the engine develops the Atkinson cycle and in the other position the Otto cycle. Or, for example, document DE102007002802A1 where the displacements of the camshaft vary the thermodynamic cycle developed by the engine between a 2-stroke and a 4-stroke.
Solutions that double the rotation frequency of the camshaft, such as document US20020117133A1 which describes a system which is able to change between a 2-stroke cycle and a 4-stroke cycle.
Document US3220392A about the Jacobs engine brake (“Jake Brake” ®), where with an additional opening of the exhaust valve, the result is that the engine acts as an air compressor that exerts a powerful engine brake.
The camless or freevalve system, from Koenigsegg, where the valves are activated electronically, without any mechanical element of rigid development that limits their movement possibilities.

Despite the many technological advances developed in the internal combustion engine, many issues remain unresolved, especially in terms of efficiency, among which are the high temperatures reached in the combustion chamber and the pollution derived from them. Contrary to all the known solutions (for example the controversial EGR valve) and taking into account the existing technical problems not resolved to date, the invention defined below is presented, consisting of an internal cooling method for internal combustion engines and the engine in which said method is applied.

### DESCRIPTION OF THE INVENTION

In a first inventive aspect, the present invention relates to an internal cooling method for internal combustion engines, wherein the engine is configured to function normally performing at least one thermodynamic cycle that produces work, and comprises:
at least one combustion chamber
at least one fuel introduction system, configured to introduce fuel into the engine,
at least one combustion chamber intake element, such as an intake valve, configured to allow the introduction of fluids, such as an oxidizer, into said combustion chamber, and
at least one combustion chamber exhaust element, such as an exhaust valve, configured to allow the exit of fluids from inside said combustion chamber;
   said cooling method being characterized by comprising an engine functioning cycle called ‘ventilation cycle’, suitable to be implemented alternatively together with the thermodynamic cycle normally performed in the engine, wherein this ‘ventilation cycle’ comprises at least one cycle of an intake phase followed by an exhaust phase, without performing any compression or expansion phases, by varying the functioning of the intake and exhaust elements in any of the combustion chambers, and wherein said ‘ventilation cycle’ is capable of being repeated as many times in succession as at least an electronic control unit decides, generating in the at least one combustion chamber on which said ‘ventilation cycle’ occurs, at least one sweep (scavenging effect) that is not to produce work, until the engine returns to the functioning mode in the thermodynamic cycle that it normally performs.

This cooling method is configured to be implemented alternately along with at least one work-producing thermodynamic cycle. That is, at some moments the engine will develop at least one thermodynamic cycle that produces work, and alternatively, at other specific moments and due to various circumstances, the engine will perform at least one cycle in the cooling method with its ‘ventilation cycle’, which is not intended for the production of work but for engine cooling. That is, both modes of functioning are alternatives in a combustion engine: when the cooling method is implemented, the usual thermodynamic cycle of the engine stops being implemented, and vice versa.

The cooling action of varying the functioning cycle performed in the combustion chambers by varying the functioning of its intake and exhaust elements, consists of a radical change in the functioning of the engine. The engine stops performing a normal thermodynamic cycle, to convert its functioning into a cooling method that performs a ‘ventilation cycle’. The engine's normal thermodynamic functioning cycle is the one that produces work and keeps it running, that is, making it work like an engine. However, the ‘ventilation cycle’ does not produce work, as its purpose is to cool the engine. Therefore, the ‘ventilation cycle’ cannot be implemented in a sustained manner in an engine, but only at specific moments, taking advantage of the inertia generated by the usual thermodynamic cycle of the engine, or that there is another source of motion generation acting at the same time in the engine. The purpose is to cool the engine before the normal thermodynamic cycle comes into functioning again.

This cooling method comprises a modification or addition of the combustion chamber intake and exhaust elements, or their functioning, and it has the capacity to perform the ‘ventilation cycle’, which comprises only 2 strokes or phases that are:
Stroke 1 or intake phase, which begins with the piston or rotor at the top dead center and begins a movement towards the bottom dead center, opening at least one combustion chamber intake element, which remains open while the combustion chamber is filled with air and/or other fluids. It concludes with the arrival of the piston or rotor at the bottom dead center, closing the at least one combustion chamber intake element.
Stroke 2 or exhaust phase, which begins with the piston or rotor at the bottom dead center and begins a movement towards the top dead center, opening at least one combustion chamber exhaust element, which remains open while the fluids are expelled outside from the combustion chamber. It concludes with the arrival of the piston or rotor at the top dead center, closing the at least one combustion chamber exhaust element.

The ‘ventilation cycle’ consists of an intake phase, followed by an exhaust phase. Carrying out several continuous “ventilation cycles” results in consecutive intake and exhaust phases, so that between two exhaust phases there is only one intake phase and between two intake phases there is only one exhaust phase. What this ‘ventilation cycle’ produces is a sweep or scavenging of the combustion chamber, which is what happens with the concatenation of stroke 4 and stroke 1 in a 4-stroke engine. The ‘ventilation cycle’ is not a normal thermodynamic cycle, since:
It is not intended to produce work,
does not include compression,
does not include combustion or explosion or expansion, and
is configured to produce combustion chamber scavenging, which is the process of replacing the fluids inside the chamber with new fluids which substitute them.

The ‘ventilation cycle’ could be activated in an engine with an adjustable system for the functioning of the combustion chamber intake and exhaust elements. In this way, the thermodynamic functioning cycle (such as Otto, Atkinson, Miller, Diesel, etc.) could be changed from time to time in an engine to the ‘ventilation cycle’, where the movements of said intake and exhaust elements are different.

The combustion chamber intake and exhaust elements may present advances or delays in their opening or closing moments with respect to the theoretical moments where the piston or rotor is at the upper or lower dead centers. These alterations are known as variable valve timing (VVT), which comprise:
Early intake valve opening (EIVO)
Late intake valve closing (LIVC)
Early exhaust valve opening (EEVO)
Late exhaust valve closing (LEVC)

These changes in the opening and closing moments with respect to their theoretical moment can be used in order to adapt the flows of air and/or other fluids to a specific or more optimal behavior, such as improved engine performance, fuel economy or emissions. For example, you can advance the opening and delay the closing of both valves, in order to create overlap in their opening moments (valve overlap) in order to improve the entry and exit of fluids at the combustion chamber, in addition to reducing pressure inside.

The management of this cooling method could be carried out from at least one distribution control unit, configured to act on the functioning of the combustion chamber intake and exhaust elements. Said at least one distribution control unit could be totally or partially integrated into the at least one electronic control unit of the engine.

In order to provide a greater description of how the ‘ventilation cycle’ works theoretically, a comparison of it with respect to the theoretical functioning of the 4-stroke Otto cycle is presented below:
The ‘ventilation cycle’ consists of only 2 strokes, compared to the 4 strokes of the Otto cycle
Consequently, the frequency of the ‘ventilation cycle’ is twice that of the Otto cycle, for the same engine revolutions.
Strokes 1 and 2 of the ‘ventilation cycle’ are comparable to strokes 1 and 4 of the Otto cycle.
In the Otto cycle, each combustion chamber intake or exhaust element only opens once every two engine revolutions (at stroke 1 the intake element and at stroke 4 the exhaust element, of the Otto cycle), while In the ‘ventilation cycle’ they open once for each engine revolution (at stroke 1 the intake element and at stroke 2 the exhaust element, of the ‘ventilation cycle’)
Consequently, the action frequency of the combustion chamber intake and exhaust elements in the ‘ventilation cycle’ is twice that of the Otto cycle, for the same engine revolutions.
In stroke 2 of the Otto cycle, compression occurs inside the combustion chamber which opposes the movement of the engine, something that does not happen in any of the strokes of the “ventilation cycle.”
At stroke 3 of the Otto cycle, there is an expansion of compressed fluids inside the combustion chamber that produce the movement of the engine (generating work), something that does not happen at any of the strokes of the “ventilation cycle.”

Compared to thermodynamic cycles, the following are some of the effects that the ‘ventilation cycle’ can produce in internal combustion engines:
increased air flow through the combustion chamber
cooling of the combustion chamber, due to the ventilation produced by sweeping it
absence of fluid compression in the combustion chamber, which entails, among others, the following consequences:
   There would be no opposition to the engine's movement, which would occur during the compression stroke of thermodynamic cycles.
   The heat that is generated in a compression would not occur.
   An additional fluid for cooling and/or lubrication and/or chemical reagent, such as water, could be introduced into the combustion chamber at any time without some adverse effects on the engine, such as excessive pressure in the combustion chamber or an expansion of vapor at the upward moment of the piston or rotor, with all valves closed, which would oppose the engine's movement.

Compared to other existing solutions (some mentioned in the technical background), this cooling method is a novel solution with inventive activity, since the specific functioning of the valves, the way it is implemented alternating together with one or more other thermodynamic cycles, and above all, the results it offers are significantly different. In essence, it is not a normal thermodynamic cycle, since it is not aimed to produce work. It is simply another way of moving engine machinery; an alternative to thermodynamic work-producing cycles which can be performed sustainably in engines. However, the ‘ventilation cycle’ cannot be developed in a sustained manner: it needs to be implemented once the motor already has inertia in its movement and just for a short time, or if there is another source of movement generation acting at the same time in the engine.

It should be noted that although the addition of a ‘ventilation cycle’ after a standard thermodynamic 4-stroke cycle can result in what is known as a “6-stroke cycle,” both things are not the same. In the 6-stroke cycle, strokes 5 and 6 occur only once, after the first 4 strokes, forming a necessary part of a 6-stroke cycle. However, the ‘ventilation cycle’ is totally independent of the other 4 strokes from the thermodynamic cycle, and it can be implemented not only when desired, but also as many consecutive times as desired.

And as for other solutions where variations in the functioning of the valves also occur, the main distinction between them and the ‘ventilation cycle’ is the result which is produced. Some solutions vary the thermodynamic cycle between Atkinson and Otto, or between 2 and 4 strokes, by means of, for example, a camshaft displacement, or a doubling of its rotation frequency. Other solutions make the engine behave as a compressor, as in the Jacobs engine brake, in order to slow the movement of the vehicle. However, the variations of the valves' functioning in the ‘ventilation cycle’ produce nothing more nor less than a sweep of the combustion chamber, in order to cool it, and also avoiding compressions, combustion or engine brake.

In particular embodiments, the cooling method comprises an additional cooling stage that is not for producing work, which comprises introducing inside the engine a cooling fluid other than air, by means of at least one fluid introduction means, such as a water injector, configured to introduce said fluid inside the engine.

In particular embodiments, the introduced cooling fluid is a specific cooling fluid other than air, such as water, and the fluid introduction means is an additional means to the elements with which the engine performs its at least one thermodynamic cycle of those that produce work, said means being specifically configured to introduce said fluid inside the engine. That is, it does not have to be a fluid and introduction means present in a conventional internal combustion engine (those used for the thermodynamic chemical reaction that normally takes place in the engine), but rather they can be exclusive to performing the cooling method. It seems to be more convenient to use a specific fluid for cooling, if for example this fluid is cheaper compared to fuel, is better for the conservation of materials, or has a higher latent heat of vaporization (or heat of vaporization, specific heat capacity or enthalpy of vaporization).

In any of the two previous particular embodiments, when introducing a cooling fluid inside the engine, this fluid acts as a kind of vector that absorbs heat and expels it to the outside. It is therefore an action that produces a great internal cooling effect in engines. The goal is to take advantage of the high latent heat of vaporization (or heat of vaporization, specific heat capacity or enthalpy of vaporization) of said fluid to cool the engine. It is a clearly different goal from other inventions, which consciously take advantage of the volumetric expansion resulting from a temperature increase of the cooling fluid in order to produce work.

The means of introduction could be, for example, a water injector in each intake manifold. Some type of lubricant or antioxidant could also be added to the cooling fluid, if better maintenance of the materials is desired. A chemical reagent could also be added in order to provoke a desirable chemical reaction, such as the transformation of certain substances harmful to the environment into others that are less polluting. Additional cooling fluid injectors could also be located anywhere on the engine (such as a turbocharger, directly in the combustion chamber, or even the exhaust) in order to achieve more localized cooling in a specific part of the engine, or along with more specific desirable chemical reactions.

In these particular embodiments, the engine cooling method has two stages: the ‘ventilation cycle’ and the introduction of a cooling fluid. Both stages are complementary, but they are not necessarily simultaneous actions at all times, but rather they are distinct and independent actions from each other. In this way, either of the two can be implemented at certain times and deactivated at others, depending on what is of interest at any given moment. Both do not always have to occur at the same time, and thus at some times the cooling method can be implemented using only the ‘ventilation cycle’. On other occasions it can be implemented using only the introduction of a cooling fluid. And on other occasions, the cooling method can be implemented using both stages or actions. But even on such joint occasions, they can unfold at any time, in any order, and in any possible combination thereof. They can be carried out in any form of presentation, such as simultaneously, alternatively, consecutively, successively, sequentially or overlapping.

The joint combination of the two stages results in the ‘ventilation cycle’ being joined by the cooling action of introducing a cooling fluid, while the introduction of fuel and ignition continue to take place in the engine. All this results in a succession of chamber sweeps with the introduction of multiple fluids, without significant compression of said fluids. All of this comprises some of the following effects:
Cooling by chamber sweep or scavenging
Cooling by the introduction of cooling fluid
Waste of the fuel supply and ignition, since if combustion or explosion of the fuel were to occur, it would be done in a very inefficient way, with little heat input to the engine and little or no use in work
If combustion or explosion of the fuel does not occur, cooling by the fuel in the engine, which absorbs the heat and expels it outside
Cancellation of the heat input normally generated in the compression phase, since this does not occur

At times when only the stage or action of introducing a cooling fluid into the engine could occur, and therefore it would be implemented together with the thermodynamic cycle performed in the engine, if it is done in a controlled manner, the combustion chamber could continue producing work, at the same time that effective cooling of the engine could be achieved.

Since the introduction of the cooling fluid has the mission of cooling the engine, it does not have to be done at a specific moment in the engine cycle, but it can be introduced at any moment or any stroke, although taking into account these three recommendations:
Minimize the alteration of the thermodynamic cycle performed in the engine, or even not affecting negatively at all.
Maximize the cooling time, so that it is longer.
Minimize adverse effects that the presence of a cooling fluid can produce in the movement of the engine, which may include:
   Reduction in fuel richness
   Pressures that the presence of the cooling fluid can generate, and that hinder the movement of the engine
   Vapor expansions that may occur in ascending moments of the piston or rotor and that generate forces contrary to its movement

The management of this stage of introducing a cooling fluid into the engine could be carried out from at least one cooling control unit, configured to act on the functioning of the at least one cooling fluid introduction element. Said at least one cooling control unit could be totally or partially integrated into the at least one electronic control unit of the engine.

It should be noted that compared to the existing solution of the 6-stroke cycle with water injection, this solution is not the same as:
nor a standard 4-stroke thermodynamic cycle, followed by a ‘ventilation cycle’ with injection of a cooling fluid
nor three consecutive “ventilation cycles”, together with injection of a cooling fluid

This is so given that:
The functioning of the combustion chamber intake and exhaust elements is different in all cases
In the 6-stroke cycle with injection, water is used for expansion purposes
in the combination of a standard thermodynamic cycle followed by a ‘ventilation cycle’, the latter can be implemented or not, on any occasion, completely intentionally and independently, and as many consecutive times as desired; while in the 6-stroke cycle, the 5th and 6th strokes necessarily occur after the first 4 strokes, and also only once in a complete cycle

In particular embodiments, the cooling method additionally comprises a cooling stage that comprises acting on at least one fuel introduction system, so that the introduction of said fuel into any of the combustion chambers is interrupted.

This particular embodiment of the engine cooling method has at least two stages. All of them are complementary, but they are not necessarily simultaneous actions at all times, but rather they are distinct and independent actions from each other. They do not have to occur together, but can be implemented at any time, in any order and in any possible combination of them. They can be carried out in any form of presentation, such as simultaneously, alternatively, consecutively, successively, sequentially or overlapping. Furthermore, these actions can be alternated in a controlled and efficient manner along with the usual thermodynamic cycle of the engine, in order to actively cool the engine, affecting its performance as little as possible.

When the previously described stages of the ‘ventilation cycle’ and this new one of fuel cut-off are carried out together, to the scavenging produced by the ‘ventilation cycle’ that enormously modifies the functioning of the engine, the absence of fuel to combust or explode or expand is added. In this way, the two main heat sources of the engine are canceled:
combustion or explosion
compression of gases.

They only remain as an insignificant contribution of heat:
the ignition (which no longer has any fuel to ignite)
the friction of the engine components and fluids that pass through it.

When the stage of introducing a cooling fluid is also added, a powerful cooling effect is additionally achieved due to the absorption of heat by said cooling fluid introduced into the interior of the engine.

In particular embodiments, the engine comprises an ignition system configured to detonate the combustion of fuel, and the cooling method comprises an additional cooling stage that comprises acting on said ignition system, so that it allows the ignition to be interrupted in any of the combustion chambers. Not all engines include an ignition system, as for example happens in Diesel cycle engines, so this cooling stage does not take place in all internal combustion engines.

This particular embodiment of the engine cooling method has at least two stages. All of them are complementary, but they are not necessarily simultaneous actions at all times, but rather they are distinct and independent actions from each other. They do not have to occur together, but can be implemented at any time, in any order and in any possible combination of them. They can be carried out in any form of presentation, such as simultaneously, alternatively, consecutively, successively, sequentially or overlapping. Furthermore, these actions can be alternated in a controlled and efficient manner along with the usual thermodynamic cycle of the engine, in order to actively cool the engine, affecting its performance as little as possible.

The cooling stages of cutting off the fuel supply and cutting off the ignition, although they are two different actions, both have the same purpose: that no fuel combustion or explosion or expansion occurs. Without those chemical reactions occurring, among other effects, the heat they would have produced would no longer be generated inside the internal combustion engine. At the same time, the engine stops producing work. The management of these cooling stages could be carried out from at least one ignition control unit, configured to act on the functioning of the fuel introduction and ignition systems. Said at least one ignition control unit could be totally or partially integrated into the at least one electronic control unit of the engine.

When the first two described stages of the ‘ventilation cycle’ and the ignition cut-off are carried out together, but the engine continues to supply fuel to the combustion chamber, as long as said fuel does not combust, cooling occurs by said fuel, which absorbs heat from inside the engine and carries it until it is expelled outside. If self-detonation or self-combustion of the fuel did occur, it would be very inefficient and with little energy input to the engine and use in work.

The joint implementation of these three stages of the cooling method: ‘ventilation cycle’, cut-off of fuel supply and cut-off of ignition (in engines that have ignition); results in what could be understood as a pure ‘ventilation cycle’, where the only purpose is to thoroughly sweep the combustion chamber with clean air, without introducing fuel or cooling fluid into the engine.

The execution of all the four stages of the cooling method in an internal combustion engine could be a very effective cooling method, as it could comprise these four effects:
Cooling by sweeping the combustion chamber (which is the ‘ventilation cycle’)
Absence of compression in the ‘ventilation cycle’, with the consequent elimination of the heat that would be generated by said compression, and the consequent elimination of the so-called “engine brake”
Cooling thanks to the absorption of heat by the cooling fluid introduced inside the engine. This cooling could be increased in the event of vaporization of said fluid
Elimination of fuel combustion or explosion or expansion, due to fuel supply cut-off and ignition cut-off

Moreover, a reduction in engine temperature could comprise the following results:
better and more efficient combustion, by being able to maintain a higher compression ratio without suffering self-detonation or self-combustion
better maintenance of materials, by working said materials in a more controlled temperature range, which subjects said materials to less stress and dilatation
a more ecological behavior of the engine, because when it reaches very high combustion temperatures, the dreaded nitrogen oxides (NOx) and microparticles begin to be generated abundantly

All these stages of the cooling method are not part of the normal functioning mode of the engine, where the thermodynamic cycle designed to produce work takes place, and therefore they are not normally part of said cycle either. Any of these stages can be implemented for a time, alternating along with the normal functioning mode of the engine. Their activation affects the functioning of the engine, since they alter or cancel the thermodynamic cycle that it develops. It means focusing on cooling the engine and forgetting about work production. That is, they are not intended to be variations of the thermodynamic cycle, adding functions or more strokes to the cycle, but rather it is a different mode of engine functioning with equally different results.

In particular embodiments, at least one of the stages of the cooling method is performed every certain number of pre-established events and during a number of also pre-established events, such as every certain time and for a certain time, or every certain number of engine revolutions and for a certain number of engine revolutions. As an example, in order to sufficiently cool the engine, it might be enough to implement the method for only 5% of the engine functioning time. This 5% could be, for example, two tenths of a second every 4 seconds of functioning, or 10 revolutions out of every 200 of the engine.

In particular embodiments, the engine comprises at least one sensor configured to detect events, such as high temperatures or certain chemical compositions of the internal fluids of the engine, and at least one of the stages of the cooling method is performed in response to the values detected by this at least one sensor. In this way, for example, the detection of a high temperature (which can begin to generate excessive pollution such as nitrogen oxides and microparticles) could be the trigger for some engine control units to activate the cooling method, in order to, for example, reduce polluting emissions, improve the energy performance of the engine, improve the maintenance of materials or increase their useful life.

In particular embodiments, the engine comprises more than one combustion chamber, and the method is characterized in that any of its stages is capable of being implemented independently in any of the combustion chambers.

In case the engine comprises more than one combustion chamber, the cooling method is capable of being performed independently in any of the combustion chambers. When the engine comprises more than one combustion chamber, the method can be carried out independently in each of them, so that any of the stages can be carried out in one, several, all or none of the combustion chambers, in any form of presentation, in any order and in any combination. That is, in addition to the actions of the cooling method being totally independent of each other, so is their implementation by combustion chamber or cylinder, which can also be carried out in any order, in any possible combination and in any form of presentation (simultaneous, alternative, consecutive, successive, sequential, overlapping or any).

As an example, the four stages of the cooling method could be implemented for a short time on only one of the cylinders, and the rest of the cylinders continue to function normally in a thermodynamic cycle that produces work. This way the engine would not suffer a sudden drop in power or performance. It would be equivalent to what is known as “running on three cylinders” (in a 4-cylinder engine), but also without getting engine braking from the inactive cylinder. Once the cylinder on which the cooling method has acted has been sufficiently cooled, it could proceed to act on another cylinder, and then on another, and so on until all the cylinders are completed.

The cooling method can be alternated in a controlled and efficient manner along with the usual thermodynamic cycle of the engine. The main objective is to optimize the joint action of better engine cooling and a lower reduction in engine power, while also trying to take care of its energy performance.

In a second inventive aspect, the invention refers to an internal combustion engine, configured to function normally performing at least one thermodynamic cycle that produces work, comprising:
at least one combustion chamber,
at least one fuel introduction system, configured to introduce fuel into the engine,
at least one combustion chamber intake element, such as an intake valve, configured to allow the introduction of fluids, such as an oxidizer, into said combustion chamber,
at least one combustion chamber exhaust element, such as an exhaust valve, configured to allow the exit of fluids from inside said combustion chamber, and
at least one electronic control unit configured to act on the functioning of different engine components;
   said engine being characterized by additionally comprising at least one means capable of varying the functioning of intake and exhaust elements in at least one combustion chamber to implement the previously called ‘ventilation cycle’, so that the engine is capable of additionally performing an internal cooling method for internal combustion engines according to any of the embodiments of the first inventive aspect, and wherein said method is implemented additionally and alternatively to a thermodynamic cycle normally performed by the engine, when the at least one electronic control unit decides so.

That is, it is an apparently normal internal combustion engine, configured to perform one or more thermodynamic cycles and produce work, but also includes elements and characteristics that allow it to perform the cooling method described above. This cooling method, since it does not produce work, is not possible to be performed autonomously and continuously in a combustion engine. However, a possible way to implement it could be in alternative combination with other thermodynamic cycles that do produce work. In this way, a thermodynamic cycle of those that produce work would be responsible for keeping the engine running, and the cooling method would be implemented interspersed between functioning periods of the thermodynamic cycle, so that the engine can be kept running autonomously.

At least one electronic control unit would be configured to act on the functioning of different engine components, in order to implement any of the stages of the cooling method:
Introduction of cooling fluid. The engine could have at least one fluid introduction means, configured to introduce a cooling fluid other than air inside the engine, and controlled by at least one electronic control unit. For example, it could be a means and a fluid already present in the elements necessary for the functioning of a thermodynamic cycle, such as a gasoline injector, which at specific times injects gasoline for cooling purposes and not combustion. Or for example, it could also be an additional means and a specific cooling fluid other than air, such as a distilled water injector.
Interruption of fuel supply. The engine could have a fuel supply cut-off system, managed by at least one electronic control unit, so that the fuel supply to at least one combustion chamber can be interrupted at will. It could be carried out, for example, thanks to the fuel injectors being directly controllable by at least one electronic control unit. Or for example thanks to at least one solenoid valve that cuts off the fuel supply to the injectors.
Interruption of engine ignition, in engines that have an ignition system to be able to perform the combustion of the fuel. Said ignition system would be controllable by at least one control unit so that the ignition can be suppressed in at least one combustion chamber.
Variation of the functioning of combustion chamber intake and exhaust elements, in order to implement the ‘ventilation cycle’. Below, different particular embodiments of the internal combustion engine are presented, which include different technical and mechanical solutions that allow the implementation of said ‘ventilation cycle’.

In particular embodiments, the engine comprises a dual drive system for the combustion chamber intake and exhaust elements, consisting of a mechanical element configured to perform the openings and closings of said intake and exhaust elements corresponding to the usual thermodynamic cycle of the engine, and also an electronic actuation system capable of performing additional openings of said intake and exhaust elements, being said electronic system controlled by at least one distribution control unit configured to manage the functioning of the combustion chamber intake and exhaust elements, so that the sum of all the openings and closings of said intake and exhaust elements allows the realization of an internal cooling method for internal combustion engines according to any of its particular embodiments.

In this particular embodiment, the at least one means with the capacity to vary the operation of combustion chamber intake and exhaust elements to implement the ‘ventilation cycle’ comprises a dual drive system for said elements. The engine has a mechanical actuation system for the combustion chamber intake and exhaust elements, such as a camshaft, which is complemented by an electronic actuation of said intake and exhaust elements. The mechanical element would be configured to perform a usual thermodynamic cycle of the engine, and the additional openings to develop the ‘ventilation cycle’ would be realized thanks to the electronic actuation system, controlled by at least one distribution control unit. In this particular embodiment, the openings caused by the mechanical element (for example the camshaft) cannot be suppressed. Only new openings can be generated at will by the electronic actuation system.

In particular embodiments, the engine comprises at least one additional distribution element, such as an additional camshaft, capable of acting directly or indirectly on the combustion chamber intake and exhaust elements, where said at least one additional distribution element:
is independent of at least one other main distribution element that acts on said intake and exhaust elements performing the usual thermodynamic cycle of the engine, and
is capable of getting activated and cause additional openings of said intake and exhaust elements;
   so that the sum of the openings and closings of the combustion chamber intake and exhaust elements allows the implementation of an internal cooling method for internal combustion engines according to any of its particular embodiments.

In this particular embodiment, the at least one means with the capacity to vary the functioning of combustion chamber intake and exhaust elements to implement the ‘ventilation cycle’ comprises at least one additional distribution element. The engine has at least one additional distribution element, such as an additional camshaft, which is activated only when it is desired to implement the ‘ventilation cycle’, remaining inactive when it is desired to implement a normal thermodynamic cycle of the engine, in which case only the at least one main distribution element would act. This at least one additional distribution element would be in charge of performing the additional openings of combustion chamber intake and exhaust elements, when it is desired to develop the ‘ventilation cycle’.

The action of the at least one additional distribution element can be directly on combustion chamber intake and exhaust elements, or on followers that affect them, or on rocker arms that are in charge of transmitting the openings of the at least one other main distribution element that is in charge of implementing the usual thermodynamic cycle of the engine.

In particular embodiments, the engine comprises additional combustion chamber intake and exhaust elements, whose openings and closings are capable of complementing the functioning of other combustion chamber main intake and exhaust elements specifically in charge of performing the usual thermodynamic cycle of the engine, so that the sum of the openings and closings of all of the combustion chamber intake and exhaust elements allows the implementation of an internal cooling method for internal combustion engines according to any of its particular embodiments.

In this particular embodiment, the at least one means with the capacity to vary the functioning of combustion chamber intake and exhaust elements to implement the ‘ventilation cycle’ comprises additional combustion chamber intake and exhaust elements. The engine has a set of main combustion chamber intake and exhaust elements, such as valves, responsible for performing a thermodynamic cycle of those that produce work. And additionally it has another set of additional or complementary combustion chamber intake and exhaust elements, such as other valves, which have the capacity to be opened at will at other precise times, allowing that in at least one combustion chamber the ‘ventilation cycle’ can be performed, thus allowing the implementation of the engine cooling method.

These additional elements would only act when the ‘ventilation cycle’ is to be implemented, remaining inactive the rest of the time. A practical embodiment of how to activate at will additional combustion chamber intake and exhaust elements, could be with an additional distribution element, such as an additional camshaft, which is activated only when it is desired to implement the ‘ventilation cycle’.

An example of adding combustion chamber intake and exhaust elements would be an engine in which in each cylinder, in addition to the intake and exhaust valves that can be called ‘main’ valves, an additional intake valve and an additional exhaust valve were added per cylinder. These extra valves would be moved thanks to at least one additional camshaft configured to act on them, and would only act selectively at certain times, to complement strokes 2 and 3 of the 4-stroke cycle. In this way, the performed cycle would be as follows:
In a first intake stroke, with the piston in downstroke, the ‘main’ intake valve would open, as corresponds to the performance of the ‘main’ valves in a 4-stroke cycle
In the following stroke, with the piston in upstroke, the additional exhaust valve would open
In the following stroke, with the piston in downstroke, the additional intake valve would open
Finally, in the following stroke with the piston in upstroke, the ‘main’ exhaust valve would open, as corresponds to the performance of the ‘main’ valves in a 4-stroke cycle

Note that in this performance, strokes 1 and 3 are equivalent, and represent an intake stroke. And strokes 2 and 4 are equivalent, and represent an exhaust stroke. Therefore, these four piston strokes (two engine revolutions) would correspond to two implementations of the ‘ventilation cycle’.

And each of these ‘ventilation cycles’ is not only a 2-stroke sequence in one engine revolution, but it is a different engine performance, which can also be reproduced for as many engine revolutions as desired, until the engine is cooled as much as desired.

Different technical solutions are described below on how to implement the activation or deactivation of combustion chamber intake and exhaust elements, in order to be able to perform the engine cooling method.

In particular embodiments, the engine comprises at least one controllable hydraulic system responsible for transmitting the actuation of at least one distribution element, such as a camshaft, to at least one combustion chamber intake or exhaust element, such as a valve, and said at least one hydraulic system comprises at least one electrohydraulic valve capable of relieving the pressure of the system, said electrohydraulic valve controlled by at least one distribution control unit configured with the capacity to reduce in any intensity the transmission of the opening impulse of the distribution element towards at least one combustion chamber intake or exhaust element, and in this way the engine is capable of performing different cycles in any combustion chamber, including an internal cooling method for internal combustion engines according to any of its particular embodiments.

In this particular embodiment, the at least one means capable of varying the functioning of intake and exhaust elements in at least one combustion chamber to implement the ‘ventilation cycle’, comprises at least one controllable hydraulic system. The engine has at least one hydraulic system responsible for opening the combustion chamber intake and/or exhaust elements, so that the actuation of a distribution element does not directly strike said intake and exhaust elements, not even on mechanical actuators such as tappets or rocker arms, but rather acts on a hydraulic system that is in direct or indirect connection with at least one combustion chamber intake or exhaust element, so that the hydraulic system transmits the action of the distribution element towards at least one combustion chamber intake or exhaust element. For example, the engine could have a camshaft that strikes at least one cylinder of a hydraulic system that is responsible for transmitting the actuation of at least one cam to at least one combustion chamber intake or exhaust valve.

All the combustion chamber intake elements can be connected to the same hydraulic system, and all the combustion chamber exhaust elements can be connected to another hydraulic system. There can also be a hydraulic system for each combustion chamber intake or exhaust element, so that each combustion chamber can have an independent functioning to the rest. There can also be any combination in between.

Each hydraulic system has at least one solenoid valve, with the capacity to release the pressure of the hydraulic system, in order to be able to cancel, totally or partially, openings of combustion chamber intake and exhaust elements that are configured by the distribution element. That is to say, for example, that some of the valve openings that a camshaft has configured in its design, may not occur thanks to the fact that a solenoid valve could release the pressure of the hydraulic system at the moment in which the actuation impulse should be transmitted from the cam to the valve.

It should be noted that this hydraulic system can cancel openings of combustion chamber intake or exhaust elements, and that said cancellation can be total or partial, but it cannot generate additional openings that are not configured in the actuation element. Therefore, thanks to the action of the hydraulic system, a functioning cycle of some combustion chamber can vary towards another cycle comprising fewer openings of combustion chamber intake or exhaust elements. However, the hydraulic system cannot cause the opposite; that a functioning cycle of some combustion chamber varies towards another cycle that comprises more openings of combustion chamber intake or exhaust elements.

In this way, the variation of all the opening and closing movements of the combustion chamber intake and exhaust elements allows different cycles to be performed in at least one combustion chamber, including the ‘ventilation cycle’ whenever their characteristic openings and closings occur.

The possibility of varying the opening and closing moments of combustion chamber intake and exhaust elements, allows that in at least one combustion chamber different cycles to be performed, including the ‘ventilation cycle’ as long as its characteristic openings and closings occur.

Among multiple possibilities of practical application of this particular embodiment, the following two practical examples are presented:
At least one hydraulic system that transmits the actuation of at least one distribution element (for example a camshaft) that is responsible for all the openings of the combustion chamber intake and exhaust elements. This practical application consists in canceling some of the openings of combustion chamber intake and exhaust elements by means of at least one controllable hydraulic system, on which a camshaft configured to perform the ‘ventilation cycle’ acts and the at least one hydraulic system comprises a solenoid valve with the capacity to cancel one of every two planned openings of each valve. In this way, the Otto cycle could be performed instead of the ‘ventilation cycle’ when the solenoid valve is canceling the appropriate valve openings. And the ‘ventilation cycle’ would be performed when the solenoid valve is not acting and therefore does not cancel any opening.
At least one hydraulic system that transmits the actuation on only a secondary system of at least one distribution element that is intended to produce additional openings of combustion chamber intake and exhaust elements, to convert the thermodynamic cycle performed by a primary distribution system into a different operating cycle. This practical example would be an engine with at least two camshafts; at least a main one performing the Otto cycle and at least a secondary one that complements the first one so that the extra openings required by the ‘ventilation cycle’ are produced. This at least one secondary camshaft would have at least one hydraulic system capable of completely canceling it during the desired time, so that when the solenoid valve releases the hydraulic system, the engine performs the Otto cycle, and when all the camshafts can perform their function, the engine performs the ‘ventilation cycle’.

In particular embodiments, the engine comprises mechanical transmission elements, such as rocker arms, responsible for mechanically transmitting the actuation of at least one distribution element, such as a camshaft, towards some combustion chamber intake or exhaust elements, such as valves, where said mechanical transmission elements are pivoting and articulated, whose articulation capacity is controllable by at least one distribution control unit, by means of a mechanism in each one of the mechanical transmission elements that, as a latch, locks or releases the articulation of each of said mechanical transmission elements; in this way, in case any articulation is left free, the actuation received by a distribution element is used to articulate the mechanical transmission element, without transmitting said actuation to its combustion chamber intake or exhaust element, and in this way the engine is capable of performing different cycles in any combustion chamber, including an internal cooling method for internal combustion engines according to any of its particular embodiments.

In this particular embodiment, the at least one means capable of varying the functioning of intake and exhaust elements in at least one combustion chamber to implement the ‘ventilation cycle’, comprises mechanical transmission elements responsible for mechanically transmitting the actuation of at least one distribution element. The engine has mechanical actuation transmission elements, such as rocker arms, which are pivoting and also articulated, but said articulation is controllable through a mechanism that, like a latch, can lock said articulation or leave it free. If the joint is left free, the actuation received by a mechanical distribution element (for example a cam) is not transmitted to its combustion chamber intake or exhaust element. A practical example, to make it easier to understand, would be articulated pivoting rocker arms with a latch, and if said latch is closed, the rocker arm is rigid and the actuation received by a cam is transmitted to a valve. However, if the latch is open, the rocker arm is articulated so that all the actuation received by the cam does not reach the valve, as it is lost causing the rocker arm to articulate.

The possibility of varying the opening and closing moments of combustion chamber intake and exhaust elements allows different cycles to be performed in at least one combustion chamber, including the ‘ventilation cycle’, provided that their characteristic openings and closings take place.

The mechanical solution of this particular embodiment can be applied in many ways, such as on a system of mechanical transmission elements (for example rocker arms) that is responsible for all the openings of the combustion chamber intake and exhaust elements (for example valves). It can also be applied, for example, to only a secondary system of mechanical transmission elements which is intended to produce additional openings of combustion chamber intake and exhaust elements (in addition to the openings performed by a primary distribution system), to convert the thermodynamic cycle performed by a primary distribution system, into another different functioning cycle. In a practical embodiment on only one secondary system, it would be applied on the pivoting and articulated rocker arms of said secondary system. If the articulations were free, they would not transmit any actuation on their valves, and therefore only the primary distribution system would act on the valves performing a thermodynamic cycle. But if the articulations were blocked, they would transmit additional actuations on the valves, therefore performing the ‘ventilation cycle’ thanks to the additional openings produced by this secondary distribution system.

In particular embodiments, the engine comprises at least one system of several mechanical transmission elements related to each other, such as a set of two or more mechanically related rocker arms, where said system:
allows the mechanical actuation of some elements to be transmitted to others, from the one receiving the actuation of at least one mechanical distribution element, such as a camshaft, to the one actuating directly or indirectly on a combustion chamber intake or exhaust element, such as a valve, and
comprises at least one displaceable element, controlled by at least one distribution control unit configured to vary the mechanical relationship between the elements of the system of mechanical transmission elements, so as to vary the mechanical incidence transmitted to the combustion chamber intake or exhaust element, thus modifying the magnitude of the openings of said intake or exhaust element;
   and in this way the engine is capable of performing different cycles in any combustion chamber, including an internal cooling method for internal combustion engines according to any of its particular embodiments.

In this particular embodiment, the at least one means capable of varying the functioning of intake and exhaust elements in at least one combustion chamber to implement the ‘ventilation cycle’, comprises at least one system of several interrelated mechanical transmission elements. A practical example to explain this particular embodiment would be a multiple rocker arm system, such as a primary rocker arm and a secondary rocker arm, where the primary rocker arm receives an actuation from a cam, and transmits it to the secondary rocker arm, which is responsible for finally transmitting said action to its valve. In this system of rocker arms, at least one is displaceable, such as undergoing a translation of the axis on which it pivots, so that the mechanical relationship between the primary rocker arm and the secondary rocker arm varies, and thus also varies the actuation transmitted to the valve. This modification of the mechanical relationship between the primary and secondary rocker arms results in a reduction in the opening movement of the valve, and said opening movement may be completely nullified.

The possibility of varying the opening and closing moments of combustion chamber intake and exhaust elements allows different cycles to be performed in at least one combustion chamber, including the ‘ventilation cycle’ as long as its characteristic openings and closings occur.

The mechanical solution of this particular embodiment can be applied in many ways, such as on a system of mechanical transmission elements (for example rocker arms) that is responsible for all the openings of the combustion chamber intake and exhaust elements (for example valves). It can also be applied, for example, on only a secondary system of mechanical transmission elements which is intended to produce additional openings of combustion chamber intake and exhaust elements (in addition to the openings performed by a primary distribution system), to convert the thermodynamic cycle performed by a primary distribution system, into another different operating cycle. In a practical embodiment on only one secondary system, it would be applied on the rocker arm assemblies of said secondary system. If the mechanical relationship between the rocker arm assemblies of each of these secondary systems were such that no mechanical actuation could be transmitted to the valves, only the primary distribution system would act on these valves, therefore performing a thermodynamic cycle. However, if the mechanical relationship between these rocker arm assemblies did allow additional valve actuation to be transmitted, then the ‘ventilation cycle’ would be performed thanks to the additional openings produced by this secondary distribution system.

In particular embodiments, the engine comprises at least one mechanical distribution element, such as a camshaft, which acts on combustion chamber intake or exhaust elements, such as valves, wherein said at least one mechanical distribution element:
is displaceable, comprising several displacement positions, which are controlled by at least one distribution control unit configured to regulate said displacement,
comprises actuation elements, such as cams, which act directly or indirectly on combustion chamber intake or exhaust elements, and
comprises at least one actuation element for each combustion chamber intake or exhaust element on which it acts, so that in at least one displacement position of said distribution element, one actuation element is arranged to act on a combustion chamber intake or exhaust element;
   and furthermore, among the actuation elements, at least one is configured to act twice as many times as the rest, as for example is the case with a two-lobe cam, and in this way the engine is capable of performing different cycles in any combustion chamber, including an internal cooling method for internal combustion engines according to any of its particular embodiments.

In this particular embodiment, the at least one means capable of varying the functioning of intake and exhaust elements in at least one combustion chamber to implement the ‘ventilation cycle’, comprises at least one mechanical distribution element acting on combustion chamber intake or exhaust elements. Displacements of said distribution element, such as longitudinal displacements with respect to its axis of rotation, can vary the functioning of the intake or exhaust elements, since said displacements can change the type of actuation elements that are arranged to act on said intake or exhaust elements. There can be three types of actuation elements:
Of the usual type, which could be referred to as ‘standard’, such as a common cam with a lobe or prominence.
Of the double type, which could be referred to as ‘ventilation’, which are configured to act twice as many times, such as a cam with two lobes or prominences arranged 180° apart, to perform the ‘ventilation cycle’.
Of the null type, which could be referred to as ‘null’, which are configured so that nothing is acted upon. It could be an absence of an actuation element in a certain position, or a cylinder without any lobe. In both cases the result would be the same, with no actuation on any valve.

The ‘standard’ type actuation elements would be configured to perform a thermodynamic cycle of engine functioning, such as the 4-stroke Otto cycle, where they act once every two engine revolutions. The ‘ventilation’ type actuation elements would be configured to perform the ‘ventilation cycle’, where they act once every engine revolution. And the ‘null’ type actuation elements would be configured to perform what is known as ‘cylinder disconnection’, where they do not act at any time during the engine revolution.

The possibility of varying the opening and closing moments of combustion chamber intake and exhaust elements, allows that different cycles can be performed in at least one combustion chamber, including the ‘ventilation cycle’ as long as its characteristic openings and closings take place.

The mechanical solution of this particular embodiment can be applied in many ways, such as on a system of at least one distribution element (for example a camshaft) that is responsible for all the openings of the combustion chamber intake and exhaust elements (for example the valves). It can also be applied, for example, on only a secondary system of at least one distribution element that is intended to produce additional openings of combustion chamber intake and exhaust elements (in addition to the openings performed by a primary distribution system), to convert the thermodynamic cycle performed by a primary distribution system in a combustion chamber, into another different operating cycle. In a practical embodiment on only one secondary system, the displacement would be applied only on the camshafts of said secondary system. If these camshafts were in a position where the cams did not act on the valves, only the primary distribution system would act on these valves, therefore performing a thermodynamic cycle. But if in another position it were to transmit additional actuations on the valves, the ‘ventilation cycle’ would be performed, thanks to the additional openings produced by this secondary distribution system.

The actuation elements (such as cams) would be grouped in groups of ‘n’ members around each combustion chamber intake or exhaust element (such as each valve), being ‘n’ the number of displacement positions of the distribution element (such as a camshaft). In this way, each group would be composed of as many actuation elements as there are different displacement positions of the distribution element, and there can be as many positions as combinations are desired. In each displacement position of the distribution element, only one actuation element of each group would be arranged to be able to act on its combustion chamber intake or exhaust element, leaving the rest of the actuation elements of the group free of any impact on any combustion chamber intake or exhaust element.

For each group of actuation elements, there can be any combination of ‘standard’, ‘ventilation’ or ‘null’ type, which can result in any combination of cycle implementation. And each group of actuation elements can be totally independent of the others, so that the cycles to be performed in each combustion chamber or cylinder could be totally independent of each other, allowing individualized implementation per cylinder.

There can be as many combinations of combustion chambers or cylinders performing each cycle as desired, and for each of them there would be a displacement position of the distribution element performing said combination. For example, an implementation of the ‘ventilation cycle’ could be carried out on a cylinder-by-cylinder basis, if there were at least as many displacement positions of the distribution element as there are cylinders on which it acts. In this case, for each displacement position, only in one cylinder the actuation elements acting on the valves would be of the ‘ventilation’ type, of those that perform the ‘ventilation cycle’. And in each displacement position, the only cylinder that would be modified to the ‘ventilation cycle’ would be different.

Regarding this last particular embodiment, a variant could be applied which would consist in adding an additional position at each of the ends, where all the actuation elements would be of the ‘standard’ type of those that perform a thermodynamic cycle that produces work. In this way, if the distribution element were positioned at one of its ends, the engine would perform the thermodynamic cycle that produces work in all its cylinders at the same time. With a sequential displacement of said distribution element to the other end, the engine would perform the ‘ventilation cycle’ one by one in all cylinders, ending in the final position where the entire engine would once again perform the thermodynamic cycle that produces work in all its cylinders.

In particular embodiments, the engine comprises at least one mechanical distribution element acting on combustion chamber intake and exhaust elements, such as a camshaft acting on valves, and a mechanism controlled by at least one distribution control unit capable of modifying the functioning frequency of said at least one distribution element and thus the opening and closing moments of its combustion chamber intake and exhaust elements; and in this way the engine is capable of performing different cycles, including an internal cooling method for internal combustion engines according to any of its particular embodiments.

In this particular embodiment, the at least one means capable of varying the functioning of intake and exhaust elements in at least one combustion chamber to implement the ‘ventilation cycle’, comprises at least one mechanical distribution element acting on combustion chamber intake or exhaust elements, and a mechanism allowing to modify the operating frequency of said at least one mechanical distribution element. The technical solution offered by this particular embodiment could allow the ‘ventilation cycle’ to be performed in a way that alternates its implementation in the engine together with a thermodynamic cycle that produces work. As an example, a mechanism or set of gears that doubles the rotation frequency of a camshaft would double the actuation frequency of the valves, and could convert an Otto cycle into a ‘ventilation cycle’. In this example, there would be an opening of the intake valve in the phases with descending stroke of the piston, and of the exhaust valve in the phases with ascending stroke of the piston, although it is true, not during the whole time that each phase lasts. In other words, what would be obtained with the camshaft rotating at twice the frequency is not a very effective ‘ventilation cycle’, but at least it can be considered as such. Subsequently, with an accurate reduction by half of the actuation frequency of the distribution element at the right time, it would be possible to return to the implementation of the usual thermodynamic cycle of the engine.

Another application example of this particular embodiment could be a mechanism that stops the rotation of at least one camshaft, in a position where no valve is open, implementing what is known as ‘cylinder disconnection’.

The possibility of varying the opening and closing moments of combustion chamber intake and exhaust elements, allows different cycles to be developed in at least one combustion chamber, including the ‘ventilation cycle’ as long as their characteristic openings and closings occur.

The mechanical solution of this particular embodiment can be applied in many ways, such as on a system of at least one distribution element (for example a camshaft) that is responsible for all the openings of the combustion chamber intake and exhaust elements (for example the valves). It can also be applied, for example, over only a secondary system of at least one distribution element which is intended to produce additional openings of combustion chamber intake and exhaust elements (in addition to the openings performed by a primary distribution system), to convert the thermodynamic cycle performed by a primary distribution system in a combustion chamber, into a different functioning cycle.

By combining the doubling of the functioning frequency of a mechanical distribution element on the one hand, together with its displacement and different types of actuation elements on the other hand, the ‘ventilation cycle’ could be implemented. This is so, since it is not essential to use two-lobe cams, but, for example, standard one-lobe cams could be used if the camshaft doubles its functioning frequency. Since in this particular embodiment the distribution element doubles its functioning frequency, its actuation elements configured to perform the ‘ventilation cycle’ could be designed to adapt to this doubling of functioning frequency of the mechanical distribution element and correctly perform the ‘ventilation cycle’ (with openings and closings of the intake and exhaust elements at precise times). In other words, for example, to stop performing the Otto cycle in an engine and start performing the ‘ventilation cycle’ could be achieved by combining these two actions:
Doubling the functioning frequency of the camshaft
Displacing said camshaft longitudinally, so that the cams that remain active, even though they are only one-lobe, are of such a shape that the opening and closing moments they cause in the valves coincide with those of the ‘ventilation cycle’.

In particular embodiments, the engine comprises an electronic drive system for combustion chamber intake and exhaust elements, controlled by at least one distribution control unit configured to manage the functioning of said intake and exhaust elements, so that the engine is capable of freely performing any cycle in any combustion chamber, including an internal cooling method for internal combustion engines according to any of its particular embodiments.

In this particular embodiment, the at least one means capable of varying the functioning of intake and exhaust elements in at least one combustion chamber to implement the ‘ventilation cycle’, comprises an electronic drive or actuation system of said combustion chamber intake and exhaust elements. With an electronic actuation system for the combustion chamber intake and exhaust elements, such as an electro-pneumatic, electro-hydraulic or electromagnetic system, controlled by at least one electronic distribution control unit, each of said elements can function in a completely free and controllable manner, without having to depend on any mechanical element of rigorous performance, such as a camshaft. An electronic drive system of this type can comprise the following advantages:
a perfect and instantaneous adaptation of the combustion chamber intake and exhaust elements, to any thermodynamic, ventilation or any other type of cycle, being able to vary freely to any desired performance easily and rapidly
a detailed adaptation of the advances and retardations of said elements to different conditions, such as different engine operating speeds, different temperature conditions or different chemical compositions of the fuel
a perfectly individualized implementation per combustion chamber or cylinder of said elements, allowing different cycles to be performed completely independently per combustion chamber or cylinder, in any possible combination

These advantages are of particular importance, since an efficient and desirable implementation of the engine cooling method object of this patent is in combination with a thermodynamic cycle of normal engine functioning. That is, that both the usual thermodynamic operating mode of the engine and any of the stages of the cooling method are performed, either alternating their implementation over time throughout the engine, or independently by combustion chamber or cylinder. In the latter case, for example, the cooling method could be performed in one cylinder, while in the rest of the cylinders could be performed a thermodynamic cycle of those that produce work. And precisely, a free and independent system of electronic actuation of the combustion chamber intake and exhaust elements would allow the desired cycle to be performed at the will of the control unit, at any time, in each combustion chamber or cylinder separately, and in any possible combination. It would even be possible to completely cancel the openings of the combustion chamber intake and exhaust elements, thus being able to implement at will the so-called ‘cylinder disconnection’.

In particular embodiments, the engine additionally comprises at least one means for introducing a cooling fluid other than air, such as a water injector, configured to introduce said fluid inside the engine according to any of the particular embodiments of the method relating to said introduction of cooling fluid, so that the engine is capable of performing an internal cooling method for internal combustion engines, according to any of its particular embodiments.

In this particular embodiment, the engine additionally comprises at least one fluid introduction means, such as for example a direct water injector into the combustion chamber, so that the engine is capable of implementing the second stage of the cooling method, which consists of introducing a cooling fluid inside the engine.

In particular embodiments, the fuel introduction system into the engine is controllable by the at least one electronic control unit, said control unit being capable of interrupting the introduction of said fuel according to the particular embodiment of the method relating to said interruption, so that the engine is capable of performing an internal cooling method for internal combustion engines, according to any of its particular embodiments.

In this particular embodiment, the control unit is capable of canceling the introduction of fuel into the combustion chambers, so that the engine is capable of not having said fuel introduction for a certain time or engine revolutions, and thus implementing the third stage of the cooling method.

In particular embodiments, the engine comprises at least one ignition system configured to detonate the combustion of the fuel, wherein said system is controllable by the at least one electronic control unit, said control unit being capable of interrupting said ignition according to the particular embodiment of the method relating to said interruption, so that the engine is capable of performing an internal cooling method for internal combustion engines, according to any of its particular embodiments.

In this particular embodiment, the engine comprises at least one fuel ignition system, such as for example at least one spark plug controlled by the at least one electronic control unit, so that the engine is capable of not having said ignition during a certain time or engine revolutions, and thus implementing the fourth stage of the cooling method.

As a summary of the whole description of the invention, the main ways this invention has for engine cooling are:
1. the modification of the opening and closing moments of the valves or combustion chamber intake and exhaust elements, to adapt them to the ‘ventilation cycle’ of the engine (by means of various alternatives described above)
2. the introduction of a cooling fluid other than air into the engine
3. the interruption of fuel intake
4. the ignition cut-off

These are tools independent from each other that can be combined in different ways to achieve internal engine cooling. All of them produce a cooling effect to a greater or lesser extent by themselves. Depending on what is of most interest at any given moment, the engine control unit will be responsible for applying these actions individually or in any combination thereof, as well as distributing them among the various cylinders in any way. The main objective is to optimize the joint action of better engine cooling and a lower engine power reduction, while also trying to take care of energy efficiency and pollution produced by the engine.

### Preferred Embodiments of the Invention

Three non-exclusive and non-limiting examples of a preferred embodiment of an internal cooling method for internal combustion engines are described below, as well as the engines to carry out said embodiments examples of the method, comprising the means and functioning described in detail below.

An Otto cycle gasoline internal combustion engine is used, comprising:
Four cylinders in line
Four gasoline direct injection electronic injectors, one per cylinder
Four additional electronic injectors for common distilled water (cooling fluid), one in each intake manifold
Two valves (one intake and one exhaust) per cylinder
A single overhead camshaft acting on all eight valves, which is displaceable in a longitudinal movement of 1.5 centimeters, presenting two possible positions at each end of the displacement, called ‘O-position’ (Otto) and ‘V-position’ (Ventilation)
A follower at the end of each valve, each 1 centimeter wide on its contact surface with the cams
Sixteen cams grouped in eight pairs (one pair for each valve), where:
   Each cam is 1 centimeter thick and the separation between cams of the same pair is 0.5 centimeters
   In each pair of cams, there is a ‘standard’ cam with a single lobe or prominence and a ‘double’ cam with two lobes or prominences, distributed in the same order in all pairs, so that the ‘standard’ cams are facing to act on the followers when the camshaft is in the ‘O-position’ and the ‘double’ cams when the camshaft is in the ‘V-position”
   In ‘double’ cams, one of the lobes or prominences is in the same orientation as the lobe or prominence of the ‘standard’ cam of its pair, and the other lobe or prominence is in the opposite orientation, with the two lobes or prominences facing each other 180°

A probe in the exhaust manifold that measures the exhaust gas outlet temperature
An electronic control unit that controls all the engine parameters, thus acting as a cooling, ignition and distribution control unit.

Since the longitudinal movement of the camshaft is 1.5 centimeters and that is also the distance between the centers of each cam within each pair of cams, at each camshaft position only one cam of each pair faces the valve follower on which it actuates.

When the engine starts, it functions in the Otto cycle, with the camshaft in the ‘O-position’. This is normal engine functioning. When the temperature probe detects a temperature above a set limit level, the engine control unit initiates a process that modifies the engine's behavior, activating the internal cooling method, which comprises these four cooling stages:
1. coolant injection, activating the additional water injectors
2. fuel injection cut-off
3. ignition cut-off
4. longitudinal displacement of the camshaft from the initial ‘O-position’ to the ‘V-Position’, causing the engine to stop functioning in the 4-stroke Otto cycle to switch to a 2-stroke ‘ventilation cycle’ (which produces continuous sweeps of the combustion chamber)

These 4 actions are implemented for a short period of time, for example two tenths of a second. During this time the engine stops working as such, since it does not produce any work. Therefore, this ventilation method needs to take advantage of the engine's inertia and is not sustainable over time. In any case, as the ‘ventilation cycle’ does not produce engine braking, these two tenths of a second do not in practice represent a serious slowdown of the engine, but simply a brief pause in its work production. After that, the control unit returns the engine to normal Otto cycle functioning, deactivating the cooling water injection, restoring the fuel intake and ignition, and returning the camshaft to the ‘O-position’.

At an engine functioning speed of, for example, 3,000 revolutions per minute, these two tenths of a second are equivalent to 10 engine revolutions, which are 10 ‘ventilation cycles’. These 10 sweeps of the combustion chambers, together with the injection of cooling water and the fuel injection and ignition cut-offs, produce a sufficiently powerful cooling effect so that the engine's internal cooling method does not have to be activated again, due to high temperatures detected, until many seconds later or even minutes.

In another example of a preferred embodiment, to perform the ‘ventilation cycle’ an additional intake valve and an additional exhaust valve per cylinder are used, so that they complement the opening and closing moments of the other valves responsible for performing the Otto cycle. Therefore, there would be the following 4 valves per cylinder:
‘O’ intake valve, actuated by a conventional camshaft, which opens in intake stage 1 of the Otto cycle of normal engine functioning.
‘O’ exhaust valve, actuated by the same conventional camshaft, which opens in exhaust stage 4 of the Otto cycle of normal engine functioning.
‘V’ exhaust valve, which only works when the ‘ventilation cycle’ is to be performed, actuated by an additional camshaft. This ‘V’ exhaust valve would only open in the upward moments of the piston in which the ‘O’ exhaust valve does not open, that is, in the stage equivalent to compression stage 2 of the Otto cycle, which has become an exhaust stage, since there is an open exhaust valve.
‘V’ intake valve, which only works when the ‘ventilation cycle’ is to be performed, actuated by the same additional camshaft. This ‘V’ intake valve would only open in the downward moments of the piston in which the ‘O’ intake valve does not open, that is, in the stage equivalent to expansion stage 3 of the Otto cycle, which has become an intake stage, since there is an open intake valve (and no compression has previously occurred, nor at that moment any combustion is occurring).

In short, the four valves complement each other so that there is always one valve open (an intake valve when the piston is descending and an exhaust valve when the piston is ascending), so that the 4-stroke Otto cycle is replaced by the 2-stroke ‘ventilation cycle’. The main camshaft driving the ‘O’ valves is absolutely standard. The additional camshaft only acts on the ‘V’ valves when the ‘ventilation cycle’ is to be implemented, so that the ‘V’ valves complement the ‘O’ valves, and all together perform the ‘ventilation cycle’.

In a last example of a preferred embodiment, instead of a mechanical valve actuation by means of a camshaft, an electronic valve drive system is used. This system is fully controllable by an electronic distribution control unit, which is capable of managing the movement of each individual valve independently and arbitrarily. With such a system it is possible to adapt each valve to any situation and at any time, without the need for any mechanical element, and the ‘ventilation cycle’ (or any other variation) can be activated whenever desired.

The main advantage of this example of a preferred embodiment compared to the previous ones, is not only the immediacy and simplicity of changing the valves' functioning, but above all that the ‘ventilation cycle’ can be applied in an individualized way per cylinder. For example, the four stages of the cooling method could start being executed on only one cylinder and only for four engine revolutions, while the rest of the cylinders continue at normal functioning. Then four engine revolutions are executed where all the engine cylinders function in normal operation mode (in the first cylinder the cooling water injection is canceled, the gasoline injection and its ignition are restored, and the valves perform the Otto cycle again). Next, the four stages of the internal cooling method are repeated again, but only on a different second cylinder and for another four engine revolutions. Next, another four revolutions are executed in the normal engine functioning in all cylinders. Then, the four stages of the internal cooling method are implemented again for another four revolutions and on only a different third cylinder, and then another four revolutions are executed in normal engine functioning in all cylinders. Finally, the four stages of the internal cooling method are executed for four revolutions on the last cylinder.

Afterwards, the engine returns to normal functioning in all cylinders continuously, until the temperature probe again detects a high temperature and the control unit again performs a new process of the internal engine cooling method, with its four cooling actions, passing sequentially one by one through all cylinders.

If the engine is running, for example, at 2,400 rpm (40 revolutions per second), four revolutions performing the internal engine cooling method occur in just 1 tenth of a second, and also in only one cylinder, with the other three remaining in normal functioning and producing torque. Therefore, this sequential application of the cooling method by all four cylinders, would lasts only seven tenths of a second. In just four moments of one tenth of a second (each) the engine functions in three cylinders, but without suffering engine braking in the only cylinder that does not produce work. In this way, the impact on the engine's work output is very limited and therefore very assumable, while the cooling is remarkable.

1. An internal cooling method for internal combustion engines, wherein the engine comprises:
at least one combustion chamber
at least one fuel introduction system, configured to introduce fuel into the engine,
at least one combustion chamber intake element, such as an intake valve, configured to allow the introduction of fluids, such as an oxidizer, into said combustion chamber, and
at least one combustion chamber exhaust element, such as an exhaust valve, configured to allow the exit of fluids from inside said combustion chamber;
said cooling method being characterized by comprising an engine functioning cycle called ‘ventilation cycle’, suitable to be implemented alternatively together with the thermodynamic cycle normally performed in the engine, wherein this ‘ventilation cycle’ comprises at least one cycle of an intake phase followed by an exhaust phase, without performing any compression or expansion phases, by varying the functioning of the intake and exhaust elements in any of the combustion chambers, and wherein said ‘ventilation cycle’ is capable of being repeated as many times in succession as at least an electronic control unit decides, generating in the at least one combustion chamber on which said ‘ventilation cycle’ occurs, at least one sweep that is not to produce work, until the engine returns to the functioning mode in the thermodynamic cycle that it normally performs.

2. Engine cooling method according to claim 1, characterized by comprising an additional cooling stage that is not for producing work, which comprises introducing inside the engine a cooling fluid other than air, by means of at least one fluid introduction means, such as a water injector, configured to introduce said fluid inside the engine.

3. Engine cooling method according to claim 2, characterized in that the introduced cooling fluid is a specific cooling fluid other than air, such as water, and the fluid introduction means is an additional means to the elements with which the engine performs its at least one thermodynamic cycle of those that produce work, said means being specifically configured to introduce said fluid inside the engine.

4. Engine cooling method according to any of the preceding claims, characterized by comprising an additional cooling stage that comprises acting on at least one fuel introduction system, so that the introduction of said fuel into any of the combustion chambers is interrupted.

5. Engine cooling method according to any of the preceding claims, where the engine comprises an ignition system configured to detonate the combustion of fuel, the cooling method being characterized for comprising an additional cooling stage that comprises acting on said ignition system, so that it allows the ignition to be interrupted in any of the combustion chambers.

6. Engine cooling method according to any of the preceding claims, where at least one of the stages of the cooling method is performed every certain number of pre-established events and during a number of also pre-established events, such as every certain time and for a certain time, or every certain number of engine revolutions and for certain number of engine revolutions.

7. Engine cooling method according to any of the preceding claims, where the engine comprises at least one sensor configured to detect events, such as high temperatures or certain chemical compositions of the internal fluids of the engine, and where at least one of the stages of the cooling method is performed in response to the values detected by this at least one sensor.

8. Engine cooling method according to any of the preceding claims, wherein the engine comprises more than one combustion chamber, the method being characterized in that any of its stages is capable of being implemented independently in any of the combustion chambers.

9. An internal combustion engine, configured to function normally performing at least one thermodynamic cycle that produces work, comprising:
at least one combustion chamber,
at least one fuel introduction system, configured to introduce fuel into the engine,
at least one combustion chamber intake element, such as an intake valve, configured to allow the introduction of fluids, such as an oxidizer, into said combustion chamber,
at least one combustion chamber exhaust element, such as an exhaust valve, configured to allow the exit of fluids from inside said combustion chamber, and
at least one electronic control unit configured to act on the functioning of different engine components;
said engine being characterized by additionally comprising at least one means capable of varying the functioning of intake and exhaust elements in at least one combustion chamber to implement the ‘ventilation cycle’ according to any of the claims 1 to 6, so that the engine is capable of additionally performing an internal cooling method for internal combustion engines according to any of the preceding claims, and wherein said method is implemented additionally and alternatively to a thermodynamic cycle normally performed by the engine, when the at least one electronic control unit decides so.

10. Combustion engine according to claim 9, that comprises a dual drive system for the combustion chamber intake and exhaust elements, consisting of a mechanical element configured to perform the openings and closings of said intake and exhaust elements corresponding to the usual thermodynamic cycle of the engine, and also an electronic actuation system capable of performing additional openings of said intake and exhaust elements, being said electronic system controlled by at least one distribution control unit configured to manage the functioning of the combustion chamber intake and exhaust elements, so that the sum of all the openings and closings of said intake and exhaust elements allows the realization of an internal cooling method for internal combustion engines according to any of claims 1 to 8.

11. Combustion engine according to any of claims 9 to 10, that comprises at least one additional distribution element, such as an additional camshaft, capable of acting directly or indirectly on the combustion chamber intake and exhaust elements, where said at least one additional distribution element:
is independent of at least one other main distribution element that acts on said intake and exhaust elements performing the usual thermodynamic cycle of the engine, and
is capable of getting activated and cause additional openings of said intake and exhaust elements;
so that the sum of the openings and closings of the combustion chamber intake and exhaust elements allows the implementation of an internal cooling method for internal combustion engines according to any of claims 1 to 8.

12. Combustion engine according to any of claims 9 to 11, that comprises additional combustion chamber intake and exhaust elements, whose openings and closings are capable of complementing the functioning of other combustion chamber main intake and exhaust elements specifically in charge of performing the usual thermodynamic cycle of the engine, so that the sum of the openings and closings of all of the combustion chamber intake and exhaust elements allows the implementation of an internal cooling method for internal combustion engines according to any of claims 1 to 8.

13. Combustion engine according to any of claims 9 to 12, that comprises at least one controllable hydraulic system responsible for transmitting the actuation of at least one distribution element, such as a camshaft, to at least one combustion chamber intake or exhaust element, such as a valve, and said at least one hydraulic system comprises at least one electrohydraulic valve capable of relieving the pressure of the system, said electrohydraulic valve controlled by at least one distribution control unit configured with capacity to reduce in any intensity the transmission of the opening impulse of the at least one distribution element towards at least one combustion chamber intake or exhaust element, and in this way the engine is capable of performing different cycles in any combustion chamber, including an internal cooling method for internal combustion engines according to any of claims 1 to 8.

14. Combustion engine according to any of claims 9 to 13, that comprises mechanical transmission elements, such as rocker arms, responsible for mechanically transmitting the actuation of at least one distribution element, such as a camshaft, towards some combustion chamber intake or exhaust elements, such as valves, where said mechanical transmission elements are pivoting and articulated, whose articulation capacity is controllable by at least one distribution control unit, by means of a mechanism in each one of the mechanical transmission elements that, as a latch, blocks or leaves free the articulation of each of said mechanical transmission elements; in this way, in case any articulation is left free, the actuation received from a distribution element is used to articulate the mechanical transmission element, without transmitting said actuation to its combustion chamber intake or exhaust element, and in this way the engine is capable of performing different cycles in any combustion chamber, including an internal cooling method for internal combustion engines according to any of claims 1 to 8.

15. Combustion engine according to any of claims 9 to 14, that comprises at least one system of several mechanical transmission elements related to each other, such as a set of two or more mechanically related rocker arms, where said system:
allows the mechanical actuation of some elements to be transmitted to others, from the one receiving the actuation of at least one mechanical distribution element, such as a camshaft, to the one actuating directly or indirectly on an intake or exhaust element to combustion chamber, such as a valve, and
comprises at least one displaceable element, controlled by at least one distribution control unit configured to vary the mechanical relationship between the elements of the system of mechanical transmission elements, so as to vary the mechanical incidence transmitted to the combustion chamber intake or exhaust element, thus modifying the magnitude of the openings of said intake or exhaust element;
and in this way the engine is capable of performing different cycles in any combustion chamber, including an internal cooling method for internal combustion engines according to any of claims 1 to 8.

16. Combustion engine according to any of claims 9 to 15, that comprises at least one mechanical distribution element, such as a camshaft, which acts on combustion chamber intake or exhaust elements, such as valves, wherein said at least one mechanical distribution element:
is displaceable, comprising several displacement positions, which are controlled by at least one distribution control unit configured to regulate said displacement,
comprises actuation elements, such as cams, which act directly or indirectly on combustion chamber intake or exhaust elements, and
comprises at least one actuation element for each combustion chamber intake or exhaust element on which it acts, so that in at least one displacement position of said distribution element, one actuation element is arranged to act on a combustion chamber intake or exhaust element;
and furthermore, among the actuation elements, at least one is configured to act twice as many times as the rest, as for example is the case with a two-lobe cam, and in this way the engine is capable of performing different cycles in any combustion chamber, including an internal cooling method for internal combustion engines according to any of claims 1 to 8.

17. Combustion engine according to any of claims 9 to 16, that comprises at least one mechanical distribution element acting on combustion chamber intake and exhaust elements, such as a camshaft acting on valves, and a mechanism controlled by at least one distribution control unit capable of modifying the functioning frequency of said at least one distribution element and thus the opening and closing moments of its combustion chamber intake and exhaust elements; and in this way the engine is capable of performing different cycles, including an internal cooling method for internal combustion engines according to any of claims 1 to 8.

18. Combustion engine according to claim 9, that comprises an electronic drive system for combustion chamber intake and exhaust elements, controlled by at least one distribution control unit configured to manage the functioning of said intake and exhaust elements, so that the engine is capable of freely performing any cycle in any combustion chamber, including an internal cooling method for internal combustion engines according to any of claims 1 to 8.

19. Combustion engine according to claim 9, that additionally comprises at least one means for introducing a cooling fluid other than air, such as a water injector, configured to introduce said fluid inside the engine according to claim 2, so that the engine is capable of performing an internal cooling method for internal combustion engines according to any of claims 1 to 8.

20. Combustion engine according to claim 9, where the fuel introduction system into the engine is controllable by the at least one electronic control unit, said control unit being capable of interrupting the introduction of said fuel according to claim 3, so that the engine is capable of performing an internal cooling method for internal combustion engines according to any of claims 1 to 8.

21. Combustion engine according to claim 9, that comprises at least one ignition system configured to detonate the combustion of the fuel, wherein said system is controllable by the at least one electronic control unit, said control unit being capable of interrupting said ignition according to claim 4, so that the engine is capable of performing an internal cooling method for internal combustion engines according to any of claims 1 to 8.
